(19) United States
(12) Patent Application Publication
(10) Pub. No.: US 2025/0367901 A1
(43) Pub. Date: Dec. 4, 2025

(54) FUEL TANK AND INSULATING COMPONENT

(71) Applicant: JAGUAR LAND ROVER LIMITED, Whitley (GB)

(72) Inventors: Chris ROBERTS, Gaydon (GB); Adam PRICE, Gaydon (GB); Prashant FERNANDES, Coventry (GB); Marc Llusa Juny, Coventry (GB)

(21) Appl. No.: 18/680,761

(22) Filed: May 31, 2024

(51) Int. Cl. B32B 3/30; B32B 3/04; B32B 5/02; B32B 5/18; B32B 5/24; B32B 5/32; B32B 27/06; B32B 27/12; B32B 37/18; B60K 15/03

(52) U.S. Cl. CPC B32B 3/30; B32B 3/04; B32B 5/02; B32B 5/18; B32B 5/245; B32B 5/32; B32B 27/065; B32B 27/12; B32B 37/18; B32B 2266/0214; B32B 2266/08; B32B 2307/302; B32B 2307/304; B32B 2439/40; B32B 2605/00; B60K 15/03; B60K 2015/03032; B60K 2015/03078

(57) ABSTRACT

Aspects of the present invention relate to a fuel tank for a wheeled vehicle, the fuel tank comprising a fuel container having an outer surface. An insulating component covers at least a portion of the outer surface, the insulating component conforming to a shape of the outer surface that it contacts and covers, the insulating component being configured to reduce, in use, an evaporation rate of fuel within the fuel tank.

### TECHNICAL FIELD

The present disclosure relates to a fuel tank and an insulating component. Aspects of the invention relate to a fuel tank having an insulating component, an insulating component for a fuel tank, a vehicle comprising a fuel tank having an insulated component, and a method of adding an insulating component to a fuel container.

### BACKGROUND

It is desirable to reduce the amount of fuel vapour that escapes from vehicle fuel tanks, for example for environmental reasons. It is an aim of the present invention to address one or more of the disadvantages associated with the prior art.

### SUMMARY OF THE INVENTION

Aspects and embodiments of the invention provide a fuel tank having an insulating component, an insulating component for a fuel tank, a vehicle comprising a fuel tank having an insulated component, and a method of adding an insulating component to a fuel container, as claimed in the appended claims.

According to an aspect of the present invention there is provided a fuel tank for a wheeled vehicle, the fuel tank comprising:
a fuel container having an outer surface; and
an insulating component covering at least a portion of the outer surface, the insulating component conforming to a shape of the outer surface that it contacts and covers, the insulating component being configured to reduce, in use, an evaporation rate of fuel within the fuel tank.

Reducing the evaporation rate of fuel may reduce the escape of fuel vapour, particularly in hot conditions.

The insulating component can take the form of a single insulating element or multiple insulating elements, which are optionally configured to at least partly interlock with each other when installed on a fuel container.

The use of multiple insulating elements may allow for more targeted insulating of regions of the fuel container that are more accessible and/or require more insulation.

The insulating component may comprise a fibrous and/or cellular insulating component. For example, the insulating component may comprise a closed-cell or open-cell polymer foam, and/or a woven or non-woven fiberglass layer.

The insulating component may comprise a laminated structure having at least two layers. Such layers can include at least one insulating layer, and/or one or more structural, reflective, or adhesive layers.

This may allow for improved performance of the insulating component.

At least part of the insulating component may be attached to the outer surface with an adhesive.

This may simplify installation of the insulating component and/or assist in maintaining it at its installed position while in service.

Optionally, the insulating component may cover at least 50%, more preferably 65%, and more preferably 80% of the outer surface.

The insulating component may cover at least 80% of a lower half of the outer surface.

At least a portion of the insulating component may define an internal surface having a three-dimensional profile, the internal surface sheathing the portion of the outer surface of the fuel container, the three-dimensional profile being self-supporting.

The use of a self-supporting profile may improve the performance of the insulating component and/or simplify its installation. “Self-supporting” in this context means that the insulating component at least partly retains its profile prior to installation of the insulating component onto the outer surface of the fuel container. The insulating component may define a three-dimensional profile such that the insulating component can only be installed onto the fuel container in one correct position and orientation.

The portion of the insulating component may comprise one or more formed shells.

The fuel tank may comprise a first formed shell that insulates at least 50% of an upper portion of the outer surface and a second formed shell that insulates at least 50% of a lower portion of the outer surface. The formed shell(s) may comprise the portion of the insulating component that defines the internal surface.

The or each formed shell may comprise a fibrous layer, and may optionally also comprise one or more other more structural, reflective, or adhesive layers.

The insulating component may comprise the or each formed shell.

At least part of the formed shell may be moulded, machined, or additively manufactured, for example.

At least part of the or each portion of the insulating component may comprise a moulded polymer. Optionally, the polymer may be cellular.

According to a further aspect of the present invention there is provided an insulating component for installation onto a fuel container to produce the fuel tank of any preceding claim, the insulating component comprising a sheet of flexible insulating material, the sheet having a shape, in plan, such that it can be wrapped around at least part of a fuel container forming part of a fuel tank, so as to insulate the fuel container.

The use of such an insulating component may provide a simple and/or low cost option for insulating a fuel tank. Optionally, the insulating component is suitable for retrofitting to an existing fuel tank.

The sheet may be shaped such that it can be wrapped around the fuel container without significant overlap. “Without significant overlap” means that less than, e.g., 10%, or more preferably less than 5% of the surface area of the sheet overlaps any other area of the sheet when installed.

The insulating component may comprise a planar blank, the blank defining, in plan, one or more recesses, the or each recess being defined by one or more edges, the recesses being configured such that a three-dimensional shape is formed when adjacent edges of the or each recess are brought towards each other. The resultant three-dimensional shape may have a profile that is complementary with at least a portion of the fuel container with which the insulating component is intended to be used.

According to a further aspect of the present invention, there is provided a method of manufacturing a fuel tank according to any aspect described herein, the method comprising:
providing a fuel container having an outer surface; and
installing the insulating component onto the fuel container so as to cover at least a portion of the outer surface, the insulating component conforming to shape of the outer surface that it covers, the insulating component being configured to reduce, in use, an evaporation rate of fuel within the fuel tank.

The insulating component may comprise a sheet of flexible insulating material, the sheet having a shape, in plan, such that it can be wrapped around at least part of a fuel container forming part of a fuel tank, the method comprising wrapping the sheet of flexible material around the fuel container.

The method may comprise covering at least some joints between adjacent edges of the sheet with an adhesive tape.

The insulating component may comprise the or each formed shell, and the method may comprise installing the or each formed shell onto the fuel container.

The method may comprise installing the fuel tank into a vehicle after the portion of the fuel container has been covered by the insulating component.

Installing the fuel tank may comprise:
positioning the fuel tank in an installation location on or in the vehicle; and installing one or more brackets to retain the fuel tank in the installation location;
wherein at least a portion of the one or more brackets compresses the insulating component against a corresponding region of the outer surface.

According to an aspect of the present invention there is provided an insulating component for a fuel container forming part of a fuel tank of a wheeled vehicle, at least a portion of the insulating component defining an internal surface having a three dimensional profile, the internal surface being configured to sheathe a portion of an outer surface of the fuel container with which the insulating component is intended to be used, the three dimensional profile being self-supporting.

The insulating component can be self-supporting prior to installation of the insulating component onto the outer surface of the fuel container. “Self-supporting” in this context may mean that the insulating component at least partly retains its profile prior to installation of the insulating component onto the outer surface of the fuel container. For example, the portion of the insulating component can be sufficiently rigid to define the shape of the internal surface without the support of, or interaction with, the outer surface.

In at least some embodiments, the insulating component may define a three-dimensional profile such that the insulating component can only be installed onto the fuel container in one correct position and orientation.

The component can take the form of a single insulating element, or multiple insulating elements that are optionally configured to interlock with each other when installed on a fuel container.

The or each insulating component is configured to reduce, in use, an evaporation rate of fuel within the fuel tank.

The or each insulating component may have a thermal conductivity of less than 0.12 W/(m·K), more preferably less than 0.09 W/(m·K), and more preferably less than 0.06 W/(m·K).

The or each insulating component may be of at least 3 mm average thickness, and more preferably of at least 4 mm average thickness.

The insulating component may comprise a formed shell. Optionally, the insulating component can comprise a plurality of formed shells. The or each formed shell can comprise the portion.

The insulating component may comprise:
a first formed shell configured to insulate at least 50% of an upper portion of the outer surface; and
a second formed shell configured to insulate at least 50% of a lower portion of the outer surface.

At least part of the or each portion may be moulded.

The insulating component may be configured to cover at least 40% of the outer surface.

The insulating component may be configured to cover at least 50%, more preferably 65%, or more preferably 80% of the outer surface.

The insulating component may be configured to cover at least 80% of a lower half of the outer surface.

The insulating component may comprise a fibrous and/or cellular insulating layer.

According to a further aspect of the present invention there is provided a fuel tank for a wheeled vehicle, the fuel tank comprising:
a fuel container having an outer surface; and
the insulating component of any aspect described herein, the insulating component covering at least a portion of the outer surface and being configured to reduce, in use, an evaporation rate of fuel within the fuel tank.

Optionally, the insulating component may comprise an upper shell covering at least 50% of an upper half of the outer surface and a lower shell covering at least 50% of a lower half of the outer surface.

Optionally, each shell may be self-supporting as defined herein.

Optionally, the upper and lower shells may engage each other along at least a portion of their respect edges.

Optionally, the edges may define interlocking profiles.

Optionally, one or more of the edges may terminate in one or more outwardly extending flanges. Flanges from adjacent shells may overlap each other.

Optionally, the shells may be clipped and/or otherwise mechanically joined to each other.

According to a further aspect of the present invention there is provided method of manufacturing a fuel tank according to any aspect described herein, the method comprising:
providing a fuel container having an outer surface; and
installing the insulating component of any aspect described herein to an outer surface of the fuel container.

The insulating component may comprise the or each formed shell, the method comprising installing the or each formed shell onto the fuel tank.

The method may comprise installing the fuel tank into a vehicle after the portion of the fuel container has been covered by the insulating component.

Installing the fuel tank may comprise:
positioning the fuel tank in or adjacent to an installation position; and installing one or more brackets to retain the fuel tank in the installation position;
wherein at least a portion of the one or more brackets compresses the insulating component against a corresponding region of the outer surface.

According to a further aspect of the present invention, there is provided a vehicle comprising the fuel tank of any aspect described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a perspective view of a vehicle in accordance with an embodiment of the invention;

FIG. 2 is a perspective view of a fuel tank in accordance with an embodiment of the invention;

FIG. 3 is a side elevation of the fuel tank of FIG. 2;

FIG. 4 is a perspective view of an insulating component for use with the embodiment of FIGS. 2 and 3, with the fuel container removed for clarity;

FIG. 5 is an underside view of the fuel tank of FIGS. 2 and 3;

FIG. 6 is an underside view of the fuel tank of FIGS. 2, 3, and 5, showing mounting brackets;

FIG. 7 is an underside view of the insulating components used in the embodiment of FIGS. 2 to 6, laid out flat;

FIG. 8 is a simplified schematic section taken through a portion of the insulation component of FIGS. 2 to 7;

FIG. 9 is a perspective view of an insulating component comprising a first shell, in accordance with an embodiment of the invention;

FIG. 10 is a perspective view of an insulating component comprising a second shell, in accordance with an embodiment of the invention;

FIG. 11 is a perspective view of a fuel tank comprising the first and second shells of FIGS. 9 and 10, in accordance with a further embodiment of the invention;

FIG. 12 is an underside perspective view of the fuel tank of FIG. 11 with brackets fitted;

FIG. 13 is a simplified schematic section through insulating components for use with the fuel tank of FIGS. 11 and 12, in accordance with a further embodiment of the invention;

FIG. 14 is a rear elevation of the fuel tank of FIGS. 11 to 13, with the first shell installed and the second shell about to be installed;

FIG. 15 is a plan view of a fuel tank comprising an insulating component, in accordance with a further embodiment of the invention;

FIG. 16 is an underside view of the fuel tank of FIG. 15;

FIG. 17 is a plan view of an insulating component comprising planar blanks, in accordance with a further embodiment of the invention;

FIG. 18 is an underside view of a fuel tank comprising the insulating component of FIG. 17, in accordance with an embodiment of the invention; and

FIG. 19 is a method in accordance with an embodiment of the invention.

### DETAILED DESCRIPTION

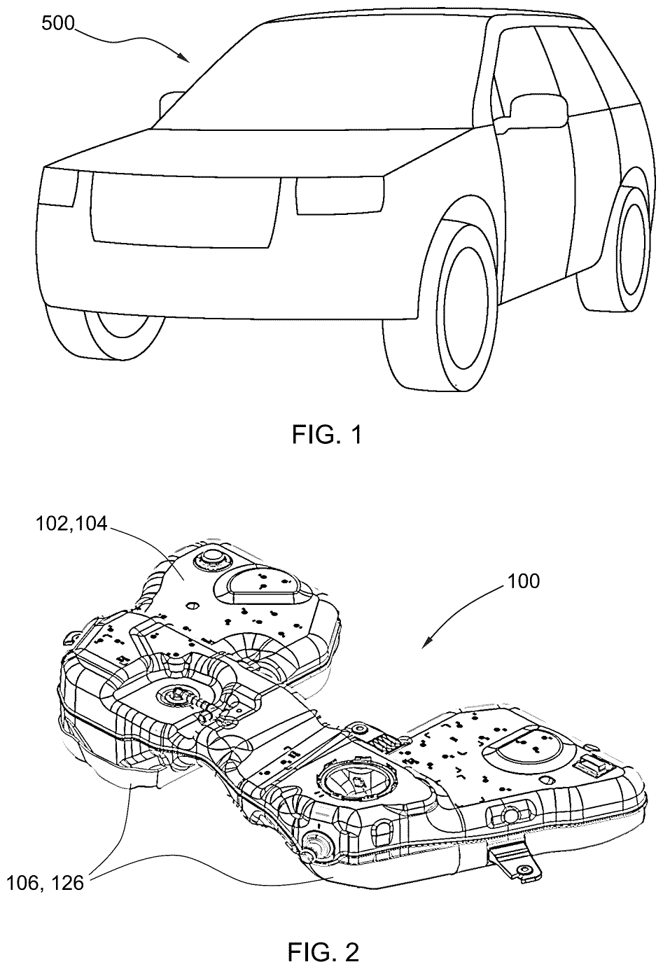

The present application describes embodiments of a fuel tank for a wheeled vehicle, such as the vehicle 500 shown in FIG. 1. A “wheeled vehicle” can include a roadgoing or off-road passenger or transport vehicle, for example.

The fuel tank comprises a fuel container having an outer surface. An insulating component covers at least a portion of the outer surface. There is also provided an insulating component and a method.

The insulating component can comprise a single layer. Alternatively, the insulating component can comprise multiple layers, for example comprising a multi-layer laminate including an insulating material, such as any of the insulating materials described herein, and one or more other layers.

Examples of such other layers include:
a substrate, webbing, or structural layer formed from a reinforcing material;
a reflective layer for reflecting radiant heat from the road or other nearby hot surfaces; and/or an adhesive layer for adhering the insulating component to the outer surface of the fuel container.

Examples of reinforcing materials include woven or non-woven polyolefins, such as polypropylene, or other polymer or non-polymer fabrics, such as felt. Examples of reflective layers include aluminium foil, reinforced aluminium foil, and aluminised polymers.

Turning to FIG. 2, there is shown a fuel tank 100. The fuel tank 100 comprises a fuel container 102 having an outer surface 104. An insulating component 106 comprising several insulating elements 126 covers corresponding regions of the outer surface 104. Each insulating element 126 conforms to a shape of the outer surface 104 that it contacts and covers. The insulating component 106 is configured to reduce, in use, an evaporation rate of fuel within the fuel tank 100.

The insulating elements 126 can optionally be configured to interlock with each other when installed on the fuel container 102. For example, FIG. 4 shows the insulating elements 126 of one half of the fuel tank 100, with the fuel container 102 removed for clarity. The insulating elements 126 abut each other along joints 118. The joints 118 include interlocking portions 120, including complementary two-dimensional formations that interlock with each other. The interlocking portions 120 help align adjacent individual insulating elements 126 with each other while they are being installed.

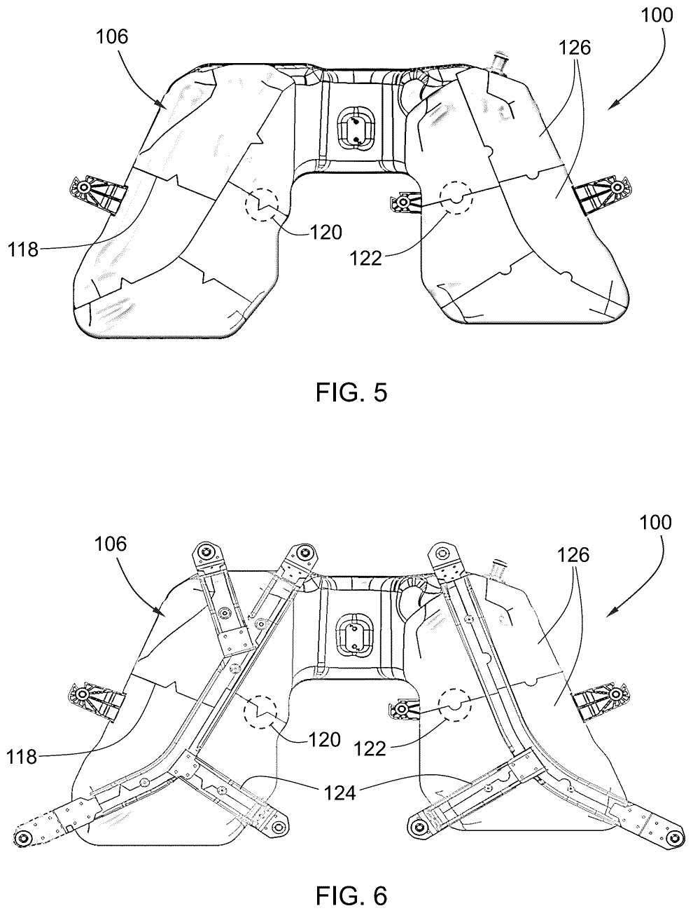

In addition, differently-shaped interlocking portions can be used to as guides for which portion of the fuel container 102 the corresponding insulating components are to be installed. For example, FIG. 5 shows the underside of the fuel tank 100. The interlocking portions 120 on one side of the fuel tank 100 include triangular shapes, whereas interlocking portions 122 on the other side of the fuel tank 100 include semicircular shapes. This reduces the chance of the insulating components being installed in the wrong place on the fuel tank 100. It will be appreciated that, in other embodiments, the interlocking portions can be the same shape on all insulating elements 126, or can take several different shapes, including being unique for each interlocking portion or section of joint 118.

The insulating elements 126 can be installed onto the fuel container 102 while it is not installed on the vehicle 500. For example, if the fuel container 100 is installed on the vehicle 500, it can be removed from the vehicle 500, allowing full access to the outer surface 104 to which the insulating components are to be applied. Alternatively, the insulating component 106 can be installed on the fuel container 102 before the fuel tank is first installed into a vehicle.

Alternatively, the insulating elements 126 can be installed by leaving the fuel container 102 in place on the vehicle, and loosening or even removing one or more brackets 124 (see FIG. 6) that are used to mount the fuel tank 100 to the vehicle 500. As each bracket 124 is loosened or removed, the insulating component(s) 106 that it covers is installed on the fuel container 102. Where an insulating element 126 is at least partly covered by more than one bracket 124, then the insulating element 126 can be partly installed under a first removed/loosened bracket 124. The removed/loosened bracket is reinstalled/tightened, and the next bracket 124 removed/loosened, allowing more of the partly installed insulating element 126 to be installed. The process is repeated until all of the insulating elements 126 are completely installed onto the fuel container 102 and the brackets 124 reinstalled/tightened.

The brackets 124 are shown as being partly transparent. This shows how some of the joints 118 extend along, and are covered by, overlying brackets 124. This helps reinforce and protect the connection between the corresponding insulating elements 126 and the fuel container 102, due to the brackets clamping down onto the edges of the insulating elements 126 along the joints 118.

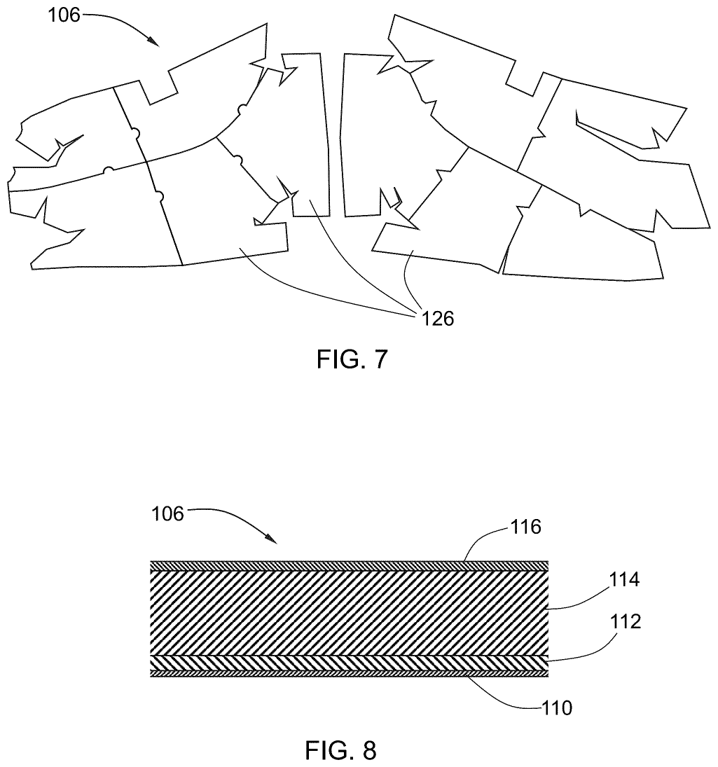

The insulating elements 126 of the fuel tank of FIGS. 2 to 8 are formed from a laminate. FIG. 8 shows a cross-section through one of the insulating elements 126. The insulating element 126 comprises an acrylic adhesive layer 110, a woven fiberglass layer 112, a felt layer 114, and an aluminium foil layer 116. The adhesive layer 110 adheres the insulating element 126 to the outer surface 104 of the fuel container 102. The fiberglass layer 112 provides a reinforcing/supporting substrate. The felt layer 114 contributes the majority of the insulating properties of the insulating component. The aluminium foil layer 116 reflects radiative heat and protects the underlying felt layer 114.

Other fibrous insulating materials, such as mineral wool or non-woven fiberglass, can be used. Alternatively, cellular insulating materials can be used, comprising materials such as nitrile rubber, butyl rubber, EPDM, or polyurethane. Such cellular insulating materials can include closed-cell materials.

Any suitable combination of insulating materials can also be used, optionally laminated to form a single component.

The insulating component 106 can have any suitable thickness. A range of thicknesses of 3-12 mm, and more preferably 4-10 mm, have been found to be effective. It will be appreciated that the thickness may vary across the or each insulating component 106 or insulating element(s) 125, for example as a result of manufacturing or installation processes. The insulation may also be made be thicker where greater insulation is desired.

The insulating component 106 can have any suitable thermal conductivity. A thermal conductivity of less than 0.12 W/(m·K), and more preferably less than 0.09 W/(m·K), has been found to be effective.

Depending upon the specific insulation requirements and the materials used, the insulating component 106 (including the insulating elements 126, where used) can cover at least 40% of the outer surface 104. In other implementations, at least 50%, more preferably 65%, and more preferably 80% of the outer surface 104 can be covered by the insulating component 106.

In addition, it is desirable that the insulating component cover at least 80% of a lower half of the outer surface 104. In this context, “lower half” means the lower region of the fuel container 102 that includes half of the total surface area of outer surface 104.

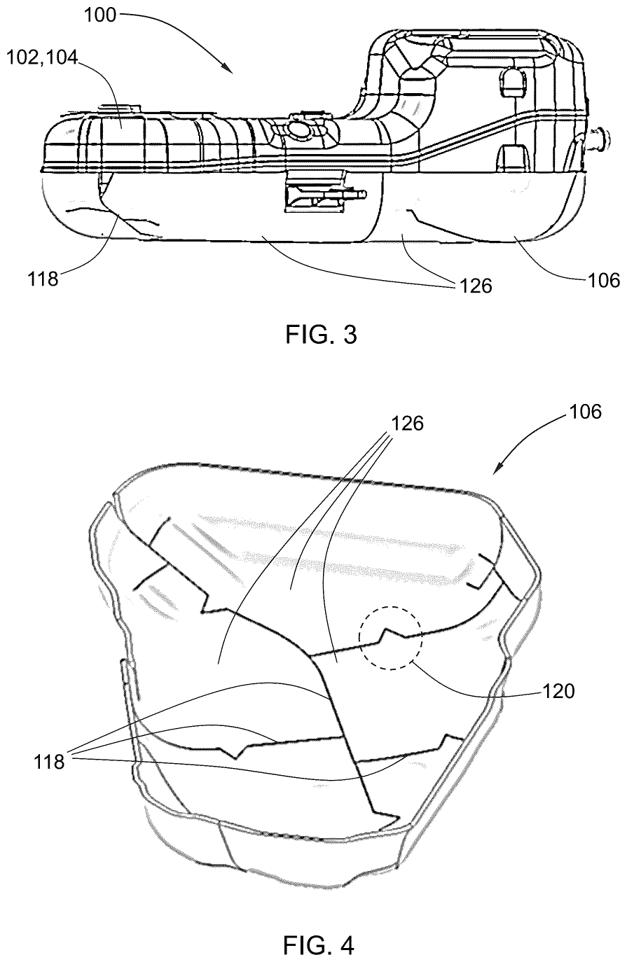

At least part of the insulating component 106 can be attached to the outer surface 104 with an adhesive. The adhesive can be applied to either or both of the insulating component 106 and the corresponding region of the outer surface 104 during manufacture. Alternatively, the insulating component 106 can be manufactured to include an adhesive layer (e.g., as described above with reference to FIG. 3), optionally with a peel-off backing layer that can be removed before the insulating component 106 is installed on the fuel container 102.

In some embodiments, the insulating component 106 can be supplied as a planar product, while being flexible enough to conform to curves in the region of the outer surface 104 to which it is applied.

Alternatively, at least a portion of the insulating component 106 can define an internal surface having a three-dimensional profile, the internal surface sheathing the corresponding portion of the outer surface of the fuel container, the three-dimensional profile being self-supporting. The three-dimensional profile can be self-supporting in the sense of at least partly retaining its profile prior to installation of the insulating component onto the outer surface of the fuel container. For example, if the insulating component is relatively stiff, it may maintain its three-dimensional profile with little or no appreciable distortion prior to installation. Alternatively, if the insulating component is less stiff, the three-dimensional profile may sag or deform somewhat prior to installation, while still retaining at least some of the required three-dimensional profile.

The insulating component may define a three-dimensional profile such that the insulating component can only be installed onto the fuel container in one correct position and orientation.

The three-dimensional profile can be achieved by forming or shaping the insulating

component in any suitable manner. For example, the insulating component can include one or more moulded elements. Such a moulded element can be formed by moulding an insulator, such as a closed-cell foam, felt, or woven fibrous insulator, within a mould having the required shape and configuration. Optionally, binders or other additives may be included to improve stiffness of the final moulded product.

Alternatively, a sheet of thermoplastic insulating material can be heated and formed in a suitable mould.

Alternatively, the insulating components can include a shaped substrate (not shown), such as a moulded or otherwise formed polymer substrate, to which has been adhered, co-moulded, or over-moulded an insulating layer (not shown), such that the insulating layer takes the shape of the underlying substrate. Other methods of forming insulating components into shapes that are self-supporting and complementary with the outer surface 104 to which they are to be attached will suggest themselves to the skilled person.

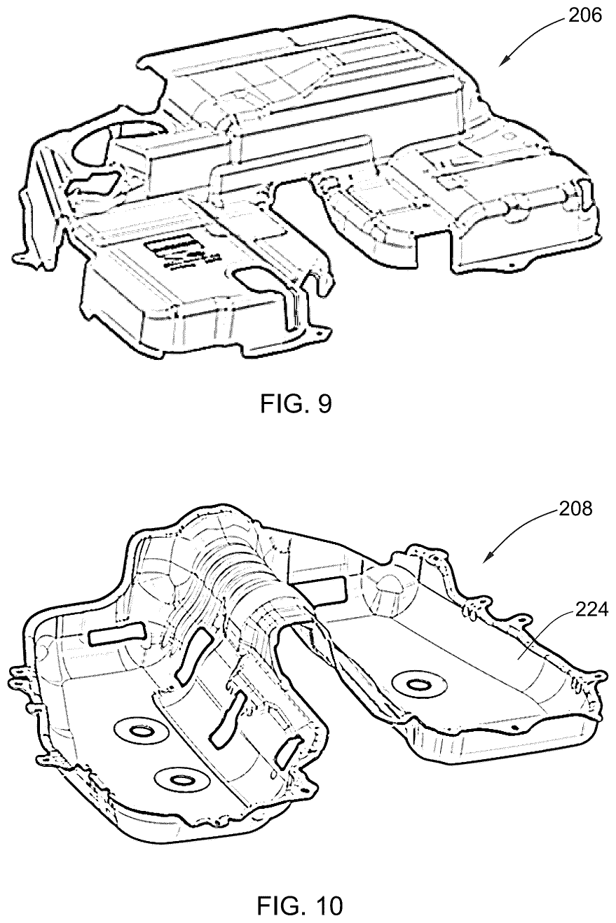

FIGS. 9 to 14 show further embodiments of the invention.

FIG. 9 shows an insulating component in the form of a first, upper shell 206, and a second, lower shell 208. Each shell 206, 208 is a preformed element. The shells 206, 208 are self-supporting, for example in the sense described above. The shells 206, 208 can be formed from, for example, a fiberglass material, optionally in the form of a composite with one or more other materials such as felt and/or cellular foam. In the illustrated embodiment, the shells 206, 208 are formed from a laminated material similar to that described in relation to FIG. 8.

Alternatively, the shells 206, 208 can be moulded from a polymer, or any other suitable insulating material, including other materials described herein. Optionally, the shells can be formed from a cellular polymer material, such as a closed-cell polymer.

The shells 206, 208 each define an internal surface 224 having a three-dimensional profile. As described in more detail below, the internal surface sheath the portion of the outer surface of the fuel container, the three-dimensional profile being self-supporting.

The use of a self-supporting profile may improve the performance of the insulating component and/or simplify its installation. “Self-supporting” in this context means that the shells at least partly retain their profile prior to installation onto the outer surface of the fuel container. The shells 206, 208 also define three-dimensional profiles such that the insulating component can only be installed onto the fuel container in one correct position and orientation.

In the illustrated embodiment, the shells 206, 208 are formed from a relatively rigid insulating material, such that they substantially maintain their three-dimensional profiles prior to installation. The use of relatively rigid shells that cover substantially all of the fuel container may reduce or obviate the need for adhesives. Optionally, the shells 206, 208 can be clipped (clips not shown) or otherwise mechanically joined together along their edges.

In other embodiments, either or both of the shells 206, 208 can be formed from two or more layers of different materials, including the various layer types and materials described above.

In other embodiments, either or both of the shells 206, 208 can at least partly be produced by machining to final form a blank or partly moulded block of insulating material. In yet other embodiments, either or both of the shells 206, 208 can at least partly be produced by an additive manufacturing process, such as three-dimensional printing.

The shells 206, 208 are configured to abut each other along at least a substantial proportion of their edges. This improves the overall insulating properties of the shells 206, 208. For example, the shells 206, 208 can be configured to abut along at least 50%, or more preferably 80%, of their edges.

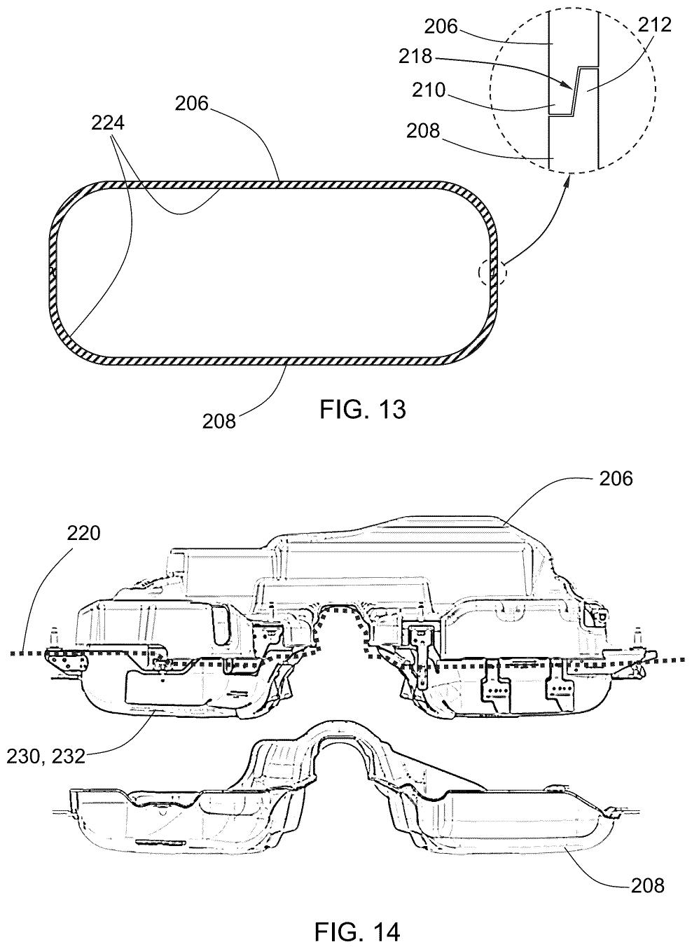

Optionally, the edges can define interlocking profiles. For example, FIG. 13 shows a cross-section through the shells 206, 208, with the fuel container omitted for clarity. The first shell 206 defines a first lip 210 extending downwardly along the inner periphery of its edge. The second shell 208 includes a second lip 212 extending upwardly along the outer periphery of its edge. The first and second lips are configured to interlock with each other as the shells 206, 208 are brought together. This may help keep the shells aligned with each other and improve the performance of the insulation where they join. The first and second lips 210, 212 include respective ramp portions 218 that assist in guiding the shells 206, 208 together during assembly.

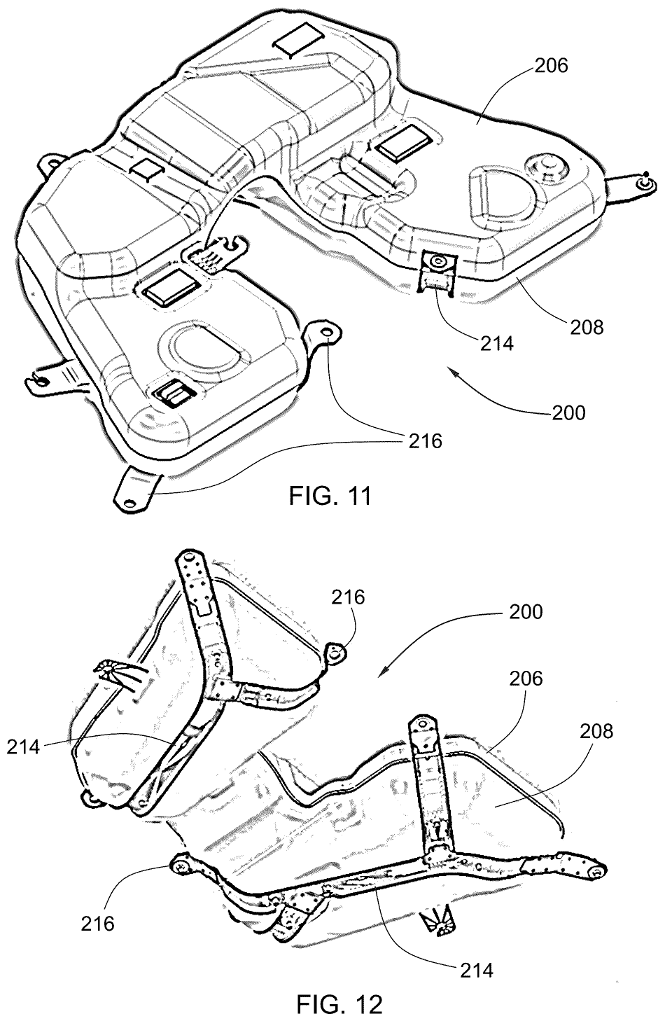

FIGS. 11 and 12 show a fuel tank 200 comprising a fuel container 230 having an outer surface 232. (The fuel container 230 and outer surface 232 are substantially covered by the upper shell 206 and the lower shell 208 in FIG. 11 or 12, but are shown in FIG. 14.) In this context, “substantially covered” can mean that at least 90% of accessible regions of the outer surface are covered by the shells 206, 208. “Accessible” regions are those that are not occupied by connectors, mounts, pads, conduits, or other difficult-to-insulate components.

The shells 206, 208 are installed onto the fuel container 202 prior to installation of the fuel tank 200 into a vehicle, such as vehicle 500. FIG. 14 shows the upper shell 206 (the lower edge of which is roughly demarcated by dotted line 220) installed onto the fuel container 230, with the fuel container 230 being lowered onto the lower shell 208.

As shown in FIG. 12, when the fuel tank 200 is installed, brackets 214 overlap the shells 206, 208, and particularly the second shell 208, and are used to attach the fuel tank 200 to the vehicle. The brackets 214 take the form of strips that follow the outer surface of the fuel tank 200, and include mounting points 216 through which connectors such as bolts (not shown) can pass to retain the brackets 204, and hence the fuel tank 200, in position on the vehicle 500.

There are additional mounting points 216 attached directly to the fuel container, around and over which the shells 206, 208 are fitted.

In other embodiments, the lower shell 208 can be installed over the top of the fuel tank, including any mounting brackets or cradle, rather than between such brackets and the fuel tank.

In an alternative embodiment, only one of the shells 206, 208 is installed onto the fuel container to provide an insulated fuel tank. For example, only the second shell 208 can be installed onto the bottom of the fuel container. This reduces cost and complexity, while reducing the overall insulating effect compared to using both shells 206, 208 (assuming the same insulating values in both cases). This trade-off may be acceptable where less insulation is needed, such as in cooler countries where fuel evaporation is less of a challenge.

In other embodiments, more or less than 90% of the outer surface may be covered by the insulating components 206, 208. For example, the first shell 206 can be configured to cover at least 50% of an upper portion of the outer surface. Similarly, the second shell 208 can be configured to cover at least 50% of a lower portion of the outer surface. Alternatively, or in addition, the first and second shells 206, 208 can together cover at least 50% of the lower portion and/or the upper portion of the outer surface. In this context, “upper portion” means an upper region of the fuel container that includes half of the total outer surface area, and “lower portion” means a lower region of the fuel container that includes half of the total outer surface area.

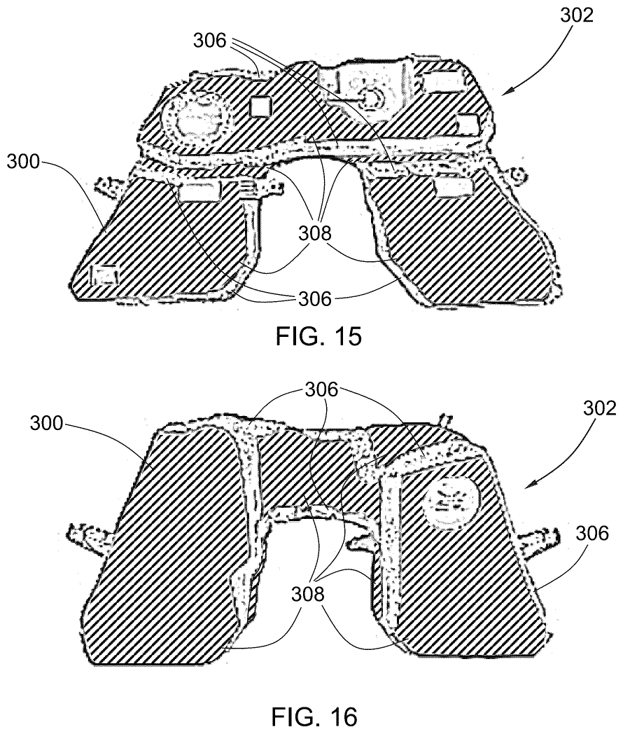

Turning to FIGS. 15 and 16, there is shown an insulating component 300 installed onto a fuel container (not shown) to produce a fuel tank 302. The insulating component comprises several sheets 308 of flexible insulating material, the sheets 308 having shapes, in plan, such that they can be wrapped around a fuel container (such as a fuel container as described herein) forming part of a fuel tank, so as to insulate the fuel container. The sheets 308 are shaded with hatching to more clearly show the are they cover.

The sheets 308 are formed from a nitrile rubber sheet, but other flexible materials can be used. The shape of each sheet 308 may be such that they can together be wrapped around the fuel container without significant overlap. “Without significant overlap” means that less than, e.g., 10%, preferably less than 5%, and more preferably none, of the surface area of each sheet 308 overlaps any other area of the sheet 300 when installed. In at least some embodiments, the sheets 308 are designed to abut with each other along at least portions of their edges, to improve the performance of the insulation and to reduce the exposure of those edges to the environment. As with previous embodiments, the sheets can avoid regions occupied by connectors, mounts, conduits, or other difficult-to-insulate components.

The sheets 308 can be adhered to the fuel container, for example using any of the adhesives and methods described above. The joins where adjacent edges of the sheets 308 abut can be joined in any suitable manner. For example, an adhesive may be used. In the embodiment of FIGS. 15 and 16, a reinforced adhesive tape 306 is used to join the abutting edges of adjacent sheets 308 after they have been applied to the fuel container.

In the embodiment of FIGS. 15 and 16, the sheets 308 cover at least 90% of the accessible regions of the outer surface.

In the embodiment of FIGS. 15 and 16, the sheets 308 are installed with the fuel container removed from the vehicle 500.

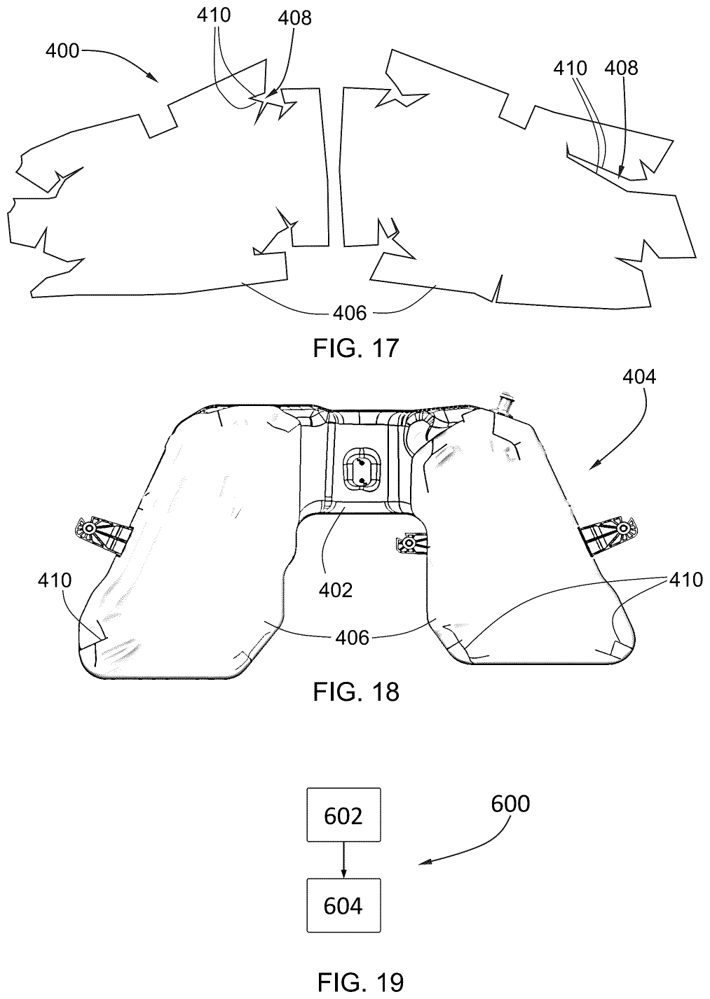

Turning to FIGS. 17 and 18, there is shown variation of the embodiment of FIGS. 15 and 16. FIG. 17 shows an insulating component 400. The insulating component 400 comprises two sheets 406 of flexible insulating material, the sheets 406 having shapes, in plan, such that they can be wrapped around at least part of a fuel container (such as a fuel container as described herein) forming part of a fuel tank, so as to insulate the fuel container.

The shape of each sheet 406 is such that they can together be wrapped around the fuel container 402
without significant overlap. “Without significant overlap” means that less than, e.g., 10%, preferably less than 5%, and more preferably none, of the surface area of each sheet 406 overlaps any other area of the sheet 406 when installed. In at least some embodiments, the sheets 406 are designed to abut with each other along at least portions of their edges, to improve the insulation and reduce the exposure of those edges to the environment. The sheets 406 cover a similar proportion of the lower half of the fuel container 402 as was shown the with embodiment of FIGS. 2 to 8.

As with previous embodiments, the sheets 406 avoid regions occupied by connectors, mounts, conduits, or other difficult-to-insulate components.

The sheets 406 can initially be adhered to the fuel container in any of the manners

described above. As with the embodiment of FIGS. 2 to 8, the sheets 406 can be applied while the fuel container 402 is uninstalled from the vehicle 500. Alternatively, the sheets 406 can be installed while the fuel container 402 remains installed on the vehicle 500, for example in the manner described above involving loosening or removing brackets,

FIG. 18 shows the insulating component 400 installed onto a fuel container 402 to produce a fuel tank 404.

The joins where adjacent edges of the sheets 406 abut can be joined in any suitable manner. For example, an adhesive may be used. In the embodiment of FIGS. 17 and 18, a reinforced adhesive tape can be used, but is not shown in the drawings for clarity.

The sheets 406 take the form of planar blanks, each blank defining, in plan, several recesses 408, each recess being defined by one or more edges 410. The recesses 408 and edges 410 are shaped such that, when the edges 410 are brought together during assembly, the recesses 408 are closed, and the blank is brought into a three-dimensional shape. The three-dimensional shape has a profile that is complementary with at least a portion of the fuel container with which the insulating component is intended to be used, as shown in FIG. 18.

Two sheets 406 are used in the embodiment of FIGS. 17 and 18. In other embodiments, a larger or smaller number of sheets may be used. In other embodiments, more, or less, of the surface area of the fuel container may be covered by the sheet(s) 406.

In all of the embodiments described above, the insulating component(s) can optionally be installed onto the fuel container prior to installation of the insulated fuel tank onto a vehicle, such as vehicle 500. Optionally, the insulating component can be positioned such that it is engaged by one or more brackets that hold the fuel tank in place on the vehicle, as described above.

Depending upon the thickness of the insulating component(s), and the thermal conductivity of the material(s) used, the rate of transfer of heat into fuel within the fuel tank may be significantly reduced. The heat may include, for example, convective and/or radiative heat from the road surface underneath the vehicle 500. Hot air from an engine compartment of the vehicle may also contribute to heating of the underside of the vehicle 500, and hence the fuel tank, especially if the vehicle is parked for a significant period of time with the engine running.

The rate at which the temperature of the fuel within the fuel tank rises will depend upon factors such as initial fuel temperature, air temperature, road surface temperature, whether the engine is running, the thermal properties of the insulating component(s), how much of the fuel tank is insulated, and various factors that will be understood by the skilled person. However, as an example, with 90% of the fuel tank covered by insulating components having a thermal conductivity of around 0.04-0.09 W/(m·K) in a relatively warm environment, the time taken to reach the 10% vol-vol boil-off point of the fuel may be increased by anything from 50% to over 200%.

Turning to FIG. 19, there is shown a method 600 of manufacturing a fuel tank according to an embodiment of the invention. The method 600 comprises: providing 602 a fuel container having an outer surface; and installing 604 the insulating component onto the fuel container so as to cover at least a portion of the outer surface, the insulating component conforming to shape of the outer surface that it covers, the insulating component being configured to reduce, in use, an evaporation rate of fuel within the fuel tank.

In certain embodiments of the method 600, the insulating component comprises a sheet of flexible insulating material, the sheet having a shape, in plan, such that it can be wrapped around a fuel container forming part of a fuel tank, the method comprising wrapping the sheet of flexible material around the fuel container. Examples of such a sheet of flexible material are shown in FIG. 17.

At least in some embodiments, the method 600 can comprise covering at least some joints between adjacent edges of the sheet with an adhesive tape, for example as shown in FIGS. 15 and 16.

When the insulating component is one or more of the shells 206, 208, the method 600 can comprise installing the or each formed shell onto the fuel container.

Optionally, the method 600 can comprise installing the fuel tank into a vehicle, such as the vehicle 500 in FIG. 1, after the portion of the fuel container has been covered by the insulating component.

Optionally, the method 600 can comprise:
positioning the fuel tank in an installation location on or in the vehicle; and installing one or more brackets to retain the fuel tank in the installation location;
wherein at least a portion of the one or more brackets compresses the insulating component against a corresponding region of the outer surface.

It will be appreciated that various changes and modifications can be made to the present invention without departing from the scope of the present application.

1. A fuel tank for a wheeled vehicle, the fuel tank comprising:
a fuel container having an outer surface; and
an insulating component covering at least a portion of the outer surface, the insulating component conforming to a shape of the outer surface that it contacts and covers, the insulating component being configured to reduce, in use, an evaporation rate of fuel within the fuel tank.

2. The fuel tank of claim 1, wherein the insulating component comprises a fibrous and/or cellular insulating component.

3. The fuel tank of claim 2, wherein the insulating component comprises a laminated structure having at least two layers.

4. The fuel tank of claim 1, wherein at least part of the insulating component is attached to the outer surface with an adhesive.

5. The fuel tank of claim 1, wherein the insulating component covers at least 40% of the outer surface.

6. The fuel tank of claim 1, wherein the insulating component covers at least 80% of a lower half of the outer surface.

7. The fuel tank of claim 1, wherein the insulating component has a thermal conductivity of less than 0.12 W/(m·K) over at least the portion of the outer surface that it covers.

8. The fuel tank of claim 1, wherein at least a portion of the insulating component defines an internal surface having a three-dimensional profile, the internal surface sheathing the portion of the outer surface of the fuel container, the three-dimensional profile being self-supporting.

9. The fuel tank of claim 8, wherein the portion of the insulating component comprises a formed shell.

10. The fuel tank of claim 8, comprising a first formed shell that insulates at least 50% of an upper portion of the outer surface and a second formed shell that insulates at least 50% of a lower portion of the outer surface.

11. The fuel tank of claim 8, wherein at least part of the or each portion of the insulating component comprises fibrous insulation.

12. An insulating component for installation onto a fuel container to produce the fuel tank of claim 1, the insulating component comprising a sheet of flexible insulating material, the sheet having a shape, in plan, such that it can be wrapped around at least part of the fuel container forming part of the fuel tank, so as to insulate the fuel container.

13. The insulating component of claim 12, the insulating component comprising a planar blank, the planar blank defining, in plan, one or more recesses, the or each recess being defined by one or more edges, the or each recess being configured such that a three-dimensional shape is formed when adjacent edges of the or each recess are brought towards each other.

14. An insulating component for the fuel tank of claim 9, the insulating component comprising the formed shell.

15. A method of manufacturing the fuel tank according to claim 1, the method comprising:
providing the fuel container having the outer surface; and
installing the insulating component onto the fuel container so as to cover at least a portion of the outer surface, the insulating component conforming to shape of the outer surface that it covers, the insulating component being configured to reduce, in use, the evaporation rate of fuel within the fuel tank.

16. The method of claim 15, wherein the insulating component comprises a sheet of flexible insulating material, the sheet having a shape, in plan, such that it can be wrapped around at least part of the fuel container forming part of the fuel tank, the method comprising wrapping the sheet of flexible material around the fuel container.

17. The method of claim 15, wherein at least a portion of the insulating component defines an internal surface having a three-dimensional profile, the internal surface sheathing the portion of the outer surface of the fuel container, the three-dimensional profile being self-supporting, and wherein the portion of the insulating component comprises a formed shell, the insulating component comprising the formed shell, the method further comprising installing the formed shell onto the fuel container.

18. The method of claim 15, further comprising installing the fuel tank into a vehicle after a portion of the fuel container has been covered by the insulating component.

19. The method of claim 18, wherein installing the fuel tank comprises:
positioning the fuel tank in an installation location on or in the vehicle; and
installing one or more brackets to retain the fuel tank in the installation location;
wherein at least a portion of the one or more brackets compresses the insulating component against a corresponding region of the outer surface.

20. A vehicle comprising the fuel tank of claim 1.
